(19) United States
(12) Patent Application Publication
(10) Pub. No.: US 2025/0039294 A1
(43) Pub. Date: Jan. 30, 2025

(54) SYSTEM AND METHOD FOR MANAGING AND RESPONDING TO INCOMING CALLS

(71) Applicant: Eli Pierre, Orlando, FL (US)

(72) Inventor: Eli Pierre, Orlando, FL (US)

(21) Appl. No.: 18/226,313

(22) Filed: Jul. 26, 2023

(51) Int. Cl. H04M 1/72472; H04M 1/72436; H04M 1/72484; H04W 8/18

(52) U.S. Cl. CPC H04M 1/72472; H04M 1/72436; H04M 1/72484; H04W 8/183

(57) ABSTRACT

The present invention discloses a system and method for managing and responding to incoming calls. The system is configured to provide different modes to create a message to respond to calls. The system is configured to display events and enable a call recipient to select an event that corresponds to a plan of the recipient. The system is configured to enable the recipient to define a duration of the selected event. The system is configured to create message comprising information and duration related to the event. The system is configured to automatically send the message to a caller, when the recipient receives a call from the caller during the predefined duration of the event. The system sends the message to the contacts assigned by the call recipient and send notification to the caller on expiration of the predefined duration of the event to indicate the availability of the call recipient.

### TECHNICAL FIELD

The present invention generally relates to management of incoming calls of a communication device. More specifically, the present invention relates to a system and method for automatically managing incoming calls of a communication device and providing a response to the incoming calls.

### BACKGROUND

Traditional Communications devices enable people to communicate with others, from almost any location on the Earth. Such communications devices typically include, but are not limited to, analog and digital and cellular phones, pagers, wireless phone handsets, wireless communicators, personal computers and laptops equipped with wireless modems, Personal Digital Assistants (PDAs), Handheld Personal Computers (HPCs), and other wireless electronic devices. While the communication device has increased the ability of individuals to communicate with others from almost any location on the Earth, there are times when a call recipient of the communications device is unavailable to take a call, or otherwise does not wish to be reached by the caller.

Generally, the call recipient has to send a follow-up message to some callers to notify them regarding their unavailability to attend the call. However, such practice is a time-consuming as it requires multiple steps including creating a new message, typing the message, and sending the message.

Few existing patent applications attempt to address the problems cited in the background as prior art over the presently disclosed subject matter and are explained as follows.

U.S. Pat. No. 11,367,060B1 of Adrian Synal et al., entitled “Automated unavailability response for call handling” discloses a method and computer-readable media for providing automated unavailability response for call handling. The method enables to notify an incoming caller that a subscriber is unavailable to answer the incoming call. The method enables an incoming call that is initiated from an originating caller device to be received at a network server for routing to a terminating user device of a specific subscriber. Further, the method retrieves a user profile of the specific subscriber that includes one or more unavailability notification settings for the incoming call from a user profile database. An unavailability notification message is selected from a data store based the unavailable notification settings. The method enables to send the unavailability notification message from the network server to the originating caller device.

US20070238474 of Paul Ballas et al., entitled “instant text reply for mobile telephony devices” discloses a cellphone program or service to allow a user to set up an instant text reply for both incoming voice calls and SMS messages from other cellphone users via an SMS message (hereinafter, Instant Text Reply) stating the reason for the user's unavailability. In use, a cellphone user could create, save, and select various outgoing SMS messages from their cellphone user interface. The cellphone user then could select the desired instant text reply message that will be automatically sent to other cellphone users attempting to contact them for a predetermined time period. However, the existing patent references lack to provide a solution that enables the user to effectively and quickly communicate their unavailability and enables the caller to know when the call recipient would be available to take the calls.

Therefore, there is a need for a system and method that enables the user or call recipient to effectively and quickly communicate their unavailability and enables the caller to know when the call recipient would be available to take the calls.

### SUMMARY

The present invention discloses a system and method for managing and responding to incoming calls. The system comprises a first user device associated with a first user, a second user device associated with a second user, at least one database configured to store information related to the first user and the second user, and at least one server in communication with the first user device, the second user device, the database via a network. The server comprises at least one memory for storing one or more program modules and at least one processor configured to execute the program modules. The modules comprise an input module, an event module, a timer module, a message creation module, a communication module, a notification module and a contact management module.

The input module is configured to provide and enable selection of at least one mode to create at least one message. The modes of messages include an audio mode, a video mode, a sticker-based mode, a text mode and an image-based mode. The event module is configured to display one or more events and enable the first user to select at least one event that corresponds to a plan of the first user. The event module is configured to group the events in one or more categories. The event module is configured to enable the first user to select at least one category to display the events grouped under the selected category.

The timer module is configured to enable the first user to define a duration of the selected event. The message creation module is configured to create the message comprising information related to the event and duration related to the event of the first user. The message comprises at least one of text, emoji, emoticons, graphics, audio, image, and video. The message provides a reason of unavailability of the first user and the duration indicates a time duration that the second user needs to wait to contact the first user in real time. The communication module is configured to automatically send the message to the second user device, when the first user receives a call from the second user during the predefined duration of the event.

In one embodiment, the first user is a call recipient, the second user is a caller, and the first user device and the second user device are a communication device. The module further comprises a notification module configured to send notification to the second user on expiration of the predefined duration of the event of the first user. The notification is a reminder indicating the availability of the first user to respond to calls.

The module further comprises a contact management module configured to enable the first user to assign one or more contacts to at least one message. The contact includes a phone number. The contact management module is further configured to store information related to contacts and corresponding message to be displayed on receiving call from the respective contact. The notification module and the communication module are further configured to automatically send the message and send the notification to the assigned contacts, respectively.

The method further discloses a method for managing and responding to incoming calls. The method comprises a step of: providing a first user device associated with a first user, a second user device associated with a second user, at least one database for storing information related to the first user and the second user, and at least one server in communication with the first user device, the second user device and the database via a network. The server comprises at least one memory for storing one or more program modules and at least one processor configured to execute the program modules. The first user is a call recipient and the second user is a caller.

The method further comprises a step of: providing, at the server via an input module, one or more modes to create the message and enabling selection of at least one mode to create at least one message. The modes of messages include an audio mode, a video mode, a sticker-based mode, a text mode and an image-based mode.

The method further comprises a step of: displaying, at the server via an event module, one or more events and enabling the first user to select at least one event that corresponds to a plan of the first user. The event module is configured to group the events in one or more categories. The event module is configured to enable the first user to select at least one category to display the events grouped under the selected category. The method further comprises a step of: enabling, at the server via a timer module, the first user to define a duration of the selected event.

The method further comprises a step of: creating, at the server via a message creation module, message comprising information related to the event and duration related to the event of the first user. The message comprises at least one of text, emoji, emoticons, graphics, audio, image, and video. The message provides a reason of unavailability of the first user to the second user and the duration indicates a time duration that the second user needs to wait to contact the first user in real time. The method further comprises a step of: automatically sending, at the server via a communication module, the message to the second user device, when the first user receives a call from the second user during the predefined duration of the event.

The method further comprises a step of: sending, at the server via a notification module, notification to the second user on expiration of the predefined duration of the event of the first user. The notification is a reminder indicating the availability of the first user to respond to calls. The method further comprises steps of: enabling, at the server via a contact management module, the first user to assign one or more contacts to at least one message. The method further comprises steps of: storing, at the server via the contact management module, information related to contacts and corresponding message to be displayed on receiving call from the respective contact. The contact includes a phone number.

The method further comprises a step of: automatically sending, at the server via the communication module, to the second user device, if the first user receives a call from the second user during the predefined duration of the event and if the first user has assigned the second user as a contact to send the message. The method further comprises steps of: automatically sending, at the server via the communication module, the message to the assigned contacts, and automatically sending, at the server via the notification module, the notification to the assigned contacts.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates an environment of a system for managing and responding to incoming calls, according to an embodiment of the present invention.

FIG. 2 exemplarily illustrates a block diagram of the components of the server and devices in communication with the server, according to an embodiment of the present invention.

FIG. 3 exemplarily illustrates a flowchart of a method for managing and responding to incoming calls of the communication device, according to an embodiment of the present invention.

FIG. 4 exemplarily illustrates a screenshot of a user interface displaying one or more options to manage incoming calls, according to an embodiment of the present invention.

FIG. 5 exemplarily illustrates a screenshot of a user interface displaying a plurality of modes to create a message, according to an embodiment of the present invention.

FIG. 6 exemplarily illustrates a screenshot of a user interface displaying a plurality of categories of events, according to an embodiment of the present invention.

FIG. 7 exemplarily illustrates a screenshot of a user interface displaying a plurality of events, according to an embodiment of the present invention.

FIG. 8 exemplarily illustrates a screenshot of a user interface displaying a sticker corresponding to the event selected by the user, according to an embodiment of the present invention.

FIG. 9 exemplarily illustrates a screenshot of a user interface to select the preferred contacts to display the message on receiving call from the preferred contacts, according to an embodiment of the present invention.

FIG. 10 exemplarily illustrates a screenshot of a user interface to set time duration during which the message needs to be displayed to the selected contacts on receiving the call, according to an embodiment of the present invention.

FIG. 11 exemplarily illustrates a screenshot of a user interface displaying a clock that enables the user to select the hour to set the duration, according to an embodiment of the present invention.

FIG. 12 exemplarily illustrates a screenshot of a user interface displaying a clock that enables the user to select the minute to set the duration, according to another embodiment of the present invention.

FIG. 13 exemplarily illustrates a screenshot of a user interface displaying the duration set by the user, according to an embodiment of the present invention.

FIG. 14 exemplarily illustrates a screenshot of a user interface displaying the message in the form of a sticker to a caller, according to an embodiment of the present invention.

FIG. 15 exemplarily illustrates a screenshot of a user interface playing the video message to the caller, according to an embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

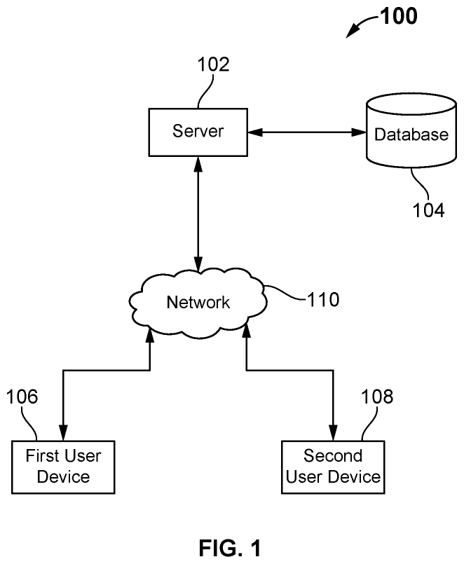

FIG. 1 exemplarily illustrates an environment 100 of a system for managing and responding to incoming calls, according to an embodiment of the present invention. The system is configured to enable the user to automatically manage incoming calls from a communication device. The system is further configured to automatically respond and send responses to incoming calls when the user is unavailable to respond to the calls from the communication device.

The system comprises a server 102 in communication with a database 104. The system comprises a first user device 106 associated with a first user and a second user device 108 associated with a second user. The first user device 106 and the second user device 108 are in communication with the server 102 via the network 110. The first user device 106 and the second user device 108 are also commonly referred as user device (106, 108). The first user and the second user are also commonly referred as user. In one example, the first user is a call recipient who is receiving a call and the second user is a caller. The second user device 108 is configured to enable the second user to place a call to the first user. The first user device 106 associated with the first user is configured to receive the call from the second user device 108.

The user device (106, 108) is a computing device configured to provide access to the service provided by the server 102. The user device (106, 108) is configured to provide an interface to access the services provided by the server 102. The interface, for example, is an application that allows the user device (106, 108) to wirelessly connect with the server 102 via the network 110. The user device (106, 108) is a communication device. The user device (106, 108) may be, for example, a desktop computer, a laptop computer, a mobile phone, a personal digital assistant, and the like.

The server 102 could be any suitable server(s) for storing information, data, programs, and/or any other suitable content. In an example, the server 102 is at least one of a general or special purpose computer. The server 102 operates as a single computer, which could be a hardware and/or software server, a workstation, a desktop, a laptop, a tablet, a mobile phone, a mainframe, a supercomputer, a server farm, and so forth. Although the server 102 is illustrated as a single device, the functions performed by server 102 could be performed using any suitable number of computing devices.

The network 110 generally represents one or more interconnected networks, over which the user device (106, 108) and the server 102 could communicate with each other. The network 110 may include packet-based wide area networks (such as the Internet), local area networks (LAN), private networks, wireless networks, satellite networks, cellular networks, paging networks, and the like. A person skilled in the art will recognize that the network 110 may also be a combination of more than one type of network. For example, the network 110 may be a combination of a LAN and the Internet. In addition, the network 110 may be implemented as a wired network or a wireless network or a combination thereof.

The database 104 is accessible by the server 102. In an example, the database 104 resides in the server 102. In another example, the database 104 resides separately from the server 102. Regardless of location, the database 104 comprises a memory to store and organize data for use by the server 102. The database 104 stores information related to the first user and information related to the second user.

The server 102 is configured to provide one or more modes to create at least one message. The server 102 is configured to enable the user to select at least one mode to create at least one message. In one embodiment, the modes of messages include, but not limited to, an audio mode, a video mode, a sticker-based mode, a text mode and an image-based mode.

The server 102 is configured to display one or more categories of events and enable the user to select at least one category. The category refers to a field of event that the user is engaged. Further, on selection of the category, the server 102 is configured to display one or more events and enable a user to select at least one event that corresponds to a plan of the user. The event refers to an activity, a task performed by the user, which prevents the user to respond to calls. The server 102 is further configured to enable the user to define a duration of the selected event. The duration refers to a time period that the user would be engaged in the event. The duration refers to a time period that the user could not attend or respond to calls.

The server 102 is further configured to enable the user to assign one or more contacts to at least one message. In an example, the contact includes a phone number. The server 102 is further configured to store information related to phone numbers and corresponding messages to be displayed on receiving the call from the respective phone numbers. The server 102 is configured to create the message comprising information related to the event and duration related to the event of the user, for example, the first user or the call recipient.

The server 102 is configured to automatically display the message on receiving a call during the defined duration of the event at the second user device 108 associated with the caller. The server 102 is further configured to send a notification to the caller on the expiration of the predefined duration of the event. The notification reminds the caller that the receiver is available to respond to calls. The server 102 is configured to automatically display the message and send the notification to the assigned contacts.

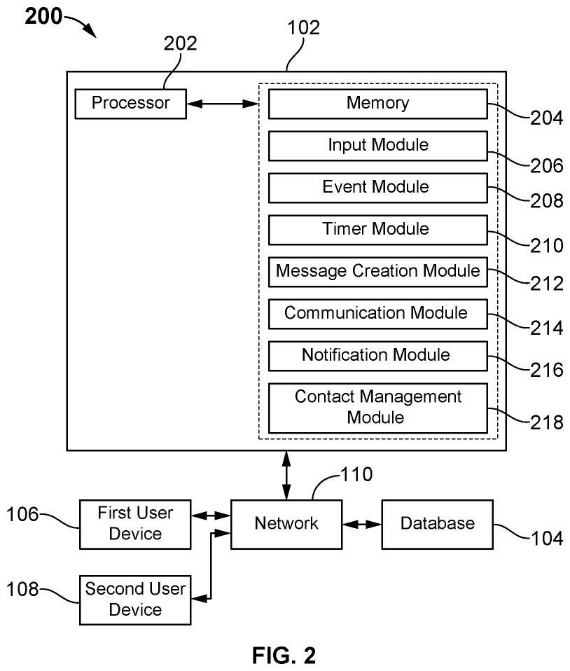

FIG. 2 exemplarily illustrates a block diagram 200 of the components of the server 102 and devices (106, 108, 104) in communication with the server 102, according to an embodiment of the present invention. The server 102 comprises one or more processors 202 and one or more memories 204 storing one or more program modules. The processor 202 is configured to execute one or more program modules. The program modules comprise an input module 206, an event module 208, a timer module 210, a message creation module 212, a communication module 214, a notification module 216 and a contact management module 218. In another embodiment, the program modules could be configured at the user device (106, 108).

The input module 206 is configured to provide one or more modes to create at least one message. The input module 206 is configured to enable the first user to select at least one mode to create at least one message. In one embodiment, the modes of messages include, but not limited to, an audio mode, a video mode, a sticker-based mode, a text mode and an image-based mode.

The event module 208 is configured to display one or more events and enable the first user to select at least one event that corresponds to a plan of the first user. The event module 208 is configured to group the events in one or more categories. The event module 208 is configured to enable the first user to select at least one category to display the events grouped under the selected category. On selection of the category, the event module 208 is configured to enable the first user to select at least one event that corresponds to the plan of the first user. In one embodiment, the event is displayed is the form of a sticker that represents the activity or event that the first user is engaged.

The timer module 210 is configured to enable the first user to define the duration of the selected event. The duration includes a start time of the selected event and an end time of the selected event. The duration refers to the time period that the first user would be engaged in the event and could not attend or respond to calls. The message creation module 212 is configured to create the message comprising information related to the event and duration related to the event of the first user. The message provides a reason of unavailability of first user to the second user and the duration indicates a time duration that the second user needs to wait to contact the first user in real time.

The communication module 214 is configured to automatically send the message on receiving the call during the defined duration of the event to the caller. For example, if the call recipient of the first user device 106 receives a call from the second user device 108, the communication module 214 is configured to automatically send the message to the second user device 108 associated with the second user or caller.

The contact management module 218 is configured to enable the user to assign one or more contacts to at least one message. In an example, the contact includes a phone number. The contact management module 218 is further configured to store information related to phone numbers and corresponding messages to be sent on receiving call from the respective phone numbers.

The notification module 216 is further configured to send notification to the caller on expiration of the predefined duration of the event. The notification reminds the caller that the receiver is available to respond to calls. The notification module 216 and the communication module 214 are configured to automatically send the message and send the notification to the assigned contacts.

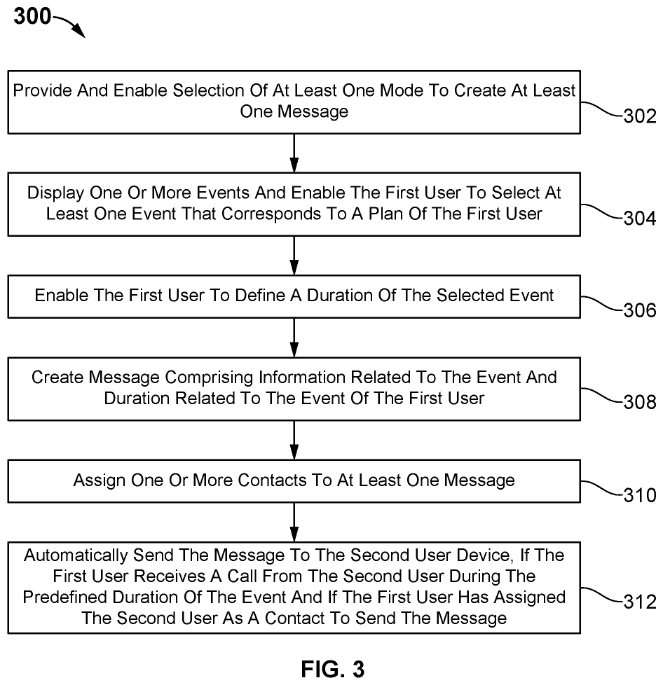

FIG. 3 exemplarily illustrates a flowchart of a method 300 for managing and responding to incoming calls of the communication device, according to an embodiment of the present invention. The method 300 is incorporated in the system comprising the first user device 106 associated with the first user, the second user device 108 associated with the second user, at least one database 104 for storing information related to the first user and the second user, and at least one server 102 in communication with the first user device 106, the second user device 108 and the database 104 via the network 110. The server 102 comprises at least one memory 204 for storing one or more program modules and at least one processor 202 configured to execute the program modules

At step 302, the input module 206 is configured to provide one or more modes to create at least one message. The input module 206 is configured to enable the first user to select at least one mode to create at least one message. In one embodiment, the modes of messages include, but not limited to, an audio mode, a video mode, a sticker-based mode, a text mode and an image-based mode.

At step 304, the event module 208 is configured to display one or more events and enable the first user to select at least one event that corresponds to a plan of the first user. The event module 208 is configured to group the events in one or more categories. The event module 208 is configured to enable the first user to select at least one category to display the events grouped under the selected category. On selection of the category, the event module 208 is configured to enable the first user to select at least one event that corresponds to the plan of the first user.

At step 306, the timer module 210 is configured to enable the first user to define the duration of the selected event.

At step 308, the message creation module 212 is configured to create the message comprising information related to the event and duration related to the event of the first user. The message provides a reason of unavailability of the first user and the duration indicates a time duration that the second user needs to wait to contact the first user in real time.

At step 310, the contact management module 218 is configured to enable the user to assign one or more contacts to at least one message. In an example, the contact includes a phone number. The contact management module 218 is further configured to store information related to phone numbers and corresponding messages to be sent on receiving call from the respective phone numbers.

At step 312, the communication module 214 is configured to automatically send the message to the second user device 108, if the first user receives a call from the second user during the predefined duration of the event and if the first user has assigned the second user as a contact to send the message. The notification module 216 is further configured to send notification to the caller on expiration of the predefined duration of the event.

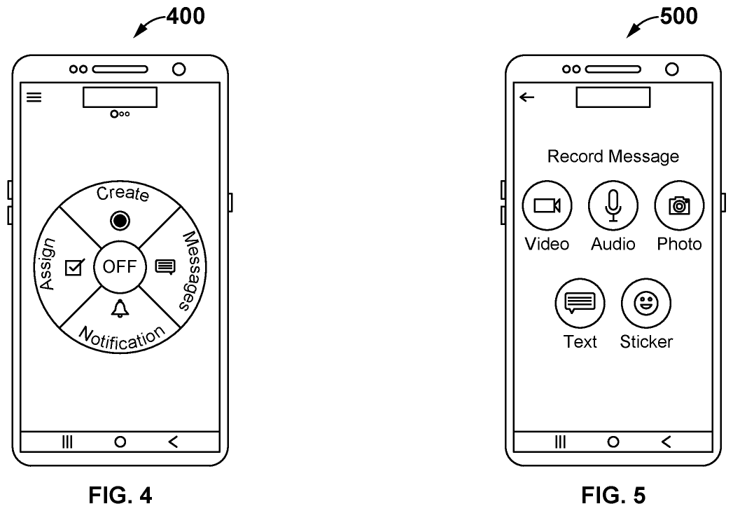

FIG. 4 exemplarily illustrates a screenshot 400 of a user interface displaying one or more options to manage incoming calls, according to an embodiment of the present invention. The server 102 is configured to provide one or more options to manage incoming calls. The options, includes, but not limited to, creating the message; assigning contacts to the created message, which enables the server 102 to send message to the assigned contacts; enable the user to automatically send notifications, once the user is available to respond to calls, and sending message to one or more contacts of the user. The options further include turn-off options.

FIG. 5 exemplarily illustrates a screenshot 500 of a user interface displaying a plurality of modes to create a message, according to an embodiment of the present invention. The modes include, but not limited to, an audio mode, a video mode, a sticker-based mode, a text mode and an image-based mode.

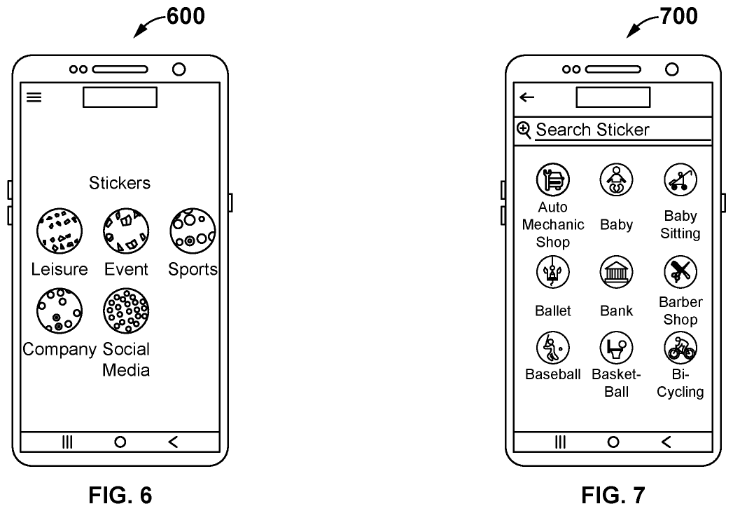

FIG. 6 exemplarily illustrates a screenshot 600 of a user interface displaying a plurality of categories of events, according to an embodiment of the present invention. The category, includes, but not limited to, leisure event, general event, sport event, company event and social media.

FIG. 7 exemplarily illustrates a screenshot 700 of a user interface displaying a plurality of events, according to an embodiment of the present invention. For example, the event includes, but not limited to, babysitting, ballet, bank, barber shop, baseball, basketball, cycling and auto-mechanic shop.

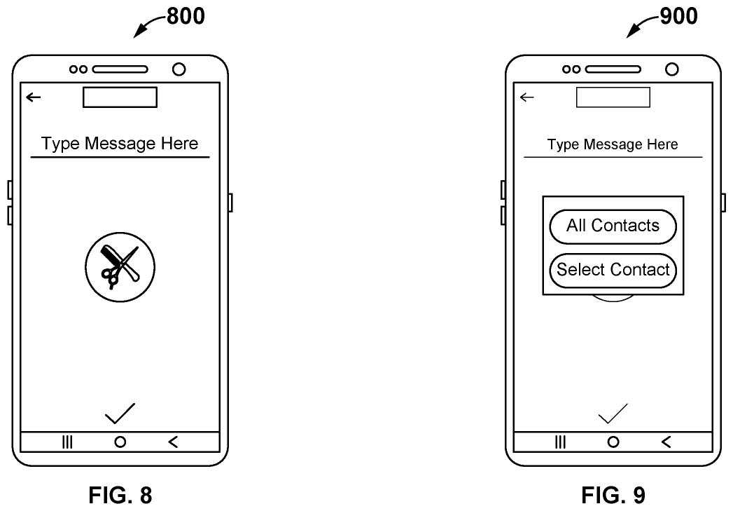

FIG. 8 exemplarily illustrates a screenshot 800 of a user interface displaying a sticker corresponding to the event selected by the user, according to an embodiment of the present invention. For example, if the user selects an event related to barber shop, the server 102 provides a sticker having scissors and combs.

FIG. 9 exemplarily illustrates a screenshot 900 of a user interface to select the preferred contacts to display the message on receiving call from the preferred contacts, according to an embodiment of the present invention.

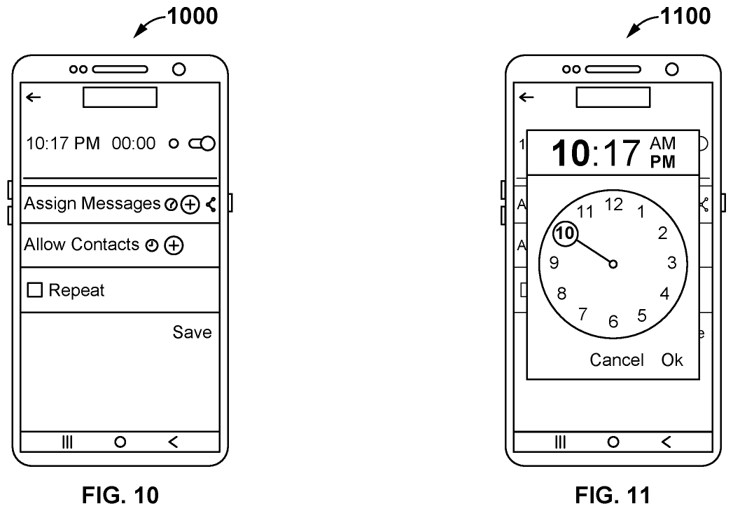

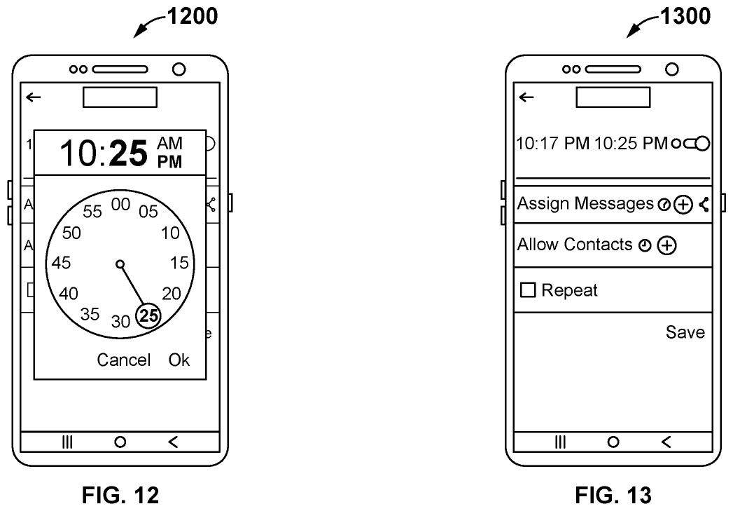

FIG. 10 exemplarily illustrates a screenshot 1000 of a user interface to set time duration during which the message needs to be displayed to the selected contacts on receiving the call, according to an embodiment of the present invention. FIG. 11 exemplarily illustrates a screenshot 1100 of a user interface displaying a clock that enables the user to select the hour to set the duration, according to an embodiment of the present invention. FIG. 12 exemplarily illustrates a screenshot 1200 of a user interface displaying a clock that enables the user to select the minute to set the duration, according to another embodiment of the present invention. FIG. 13 exemplarily illustrates a screenshot 1300 of a user interface displaying the duration set by the user, according to an embodiment of the present invention. Referring to FIG. 10 to FIG. 13, the server 102 enables set a duration, for example, 10.17 PM to 10.25 PM, as a duration that the user would be unavailable to take calls. The server 102 further enables the user to assign messages and assign contacts.

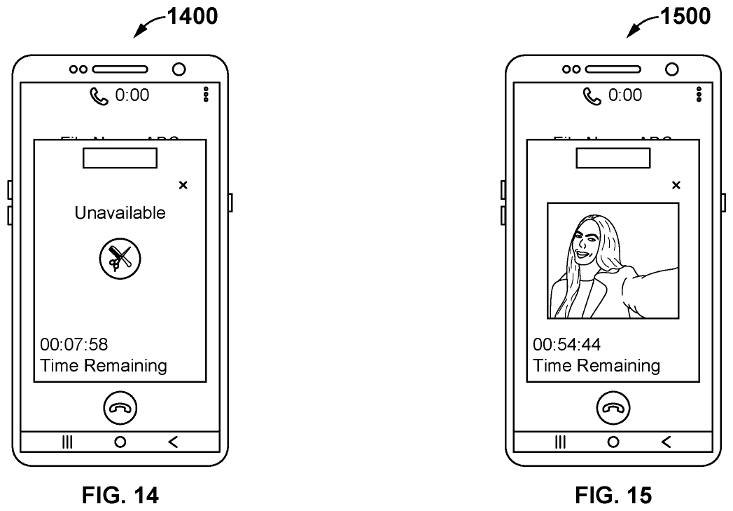

FIG. 14 exemplarily illustrates a screenshot 1400 of a user interface displaying the message in the form of a sticker to a caller, according to an embodiment of the present invention. The server 102 displays a sticker representing the activity that the call recipient is engaged and the time that the call recipient would be unavailable to take calls. The server 102 displays the sticker to the caller.

FIG. 15 exemplarily illustrates a screenshot 1500 of a user interface playing the video message to the caller, according to an embodiment of the present invention. The server 102 is configured to play a video message of the call recipient to the caller and the time duration that the call recipient would be unavailable to take calls. Further, the duration indicates a time that the second user needs to wait to contact the first user in real time

Advantageously, the system enables the user to create a video or other mediums of messaging to intercept incoming calls or text by way of privacy. Further, the system automatically sends the callers a pop up of the assigned message and remaining time frame in the duration specified by the user, informing the caller the reason for the user's absence. Further, the system sends the callers a notification once the user's set time for messages expires.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A system for managing and responding to incoming calls, comprising:
a first user device associated with a first user;
a second user device associated with a second user;
at least one database configured to store information related to the first user and the second user, and
at least one server in communication with the first user device, the second user device, the database via a network, wherein the server comprises at least one memory for storing one or more program modules and at least one processor configured to execute the program modules, wherein the modules comprise:
an input module configured to provide and enable selection of at least one mode to create at least one message;
an event module configured to display one or more events and enable the first user to select at least one event that corresponds to a plan of the first user;
a timer module configured to enable the first user to define a duration of the selected event;
a message creation module configured to create the message comprising information related to the event and duration related to the event of the first user, wherein the message provides a reason of unavailability of the first user and the duration indicates a time duration that the second user needs to wait to contact the first user in real time, and
a communication module configured to automatically send the message to the second user device, when the first user receives a call from the second user during the predefined duration of the event.

2. The system of claim 1, wherein the first user is a call recipient and the second user is a caller, and wherein the first user device and the second user device are a communication device.

3. The system of claim 1, wherein the module further comprises a notification module configured to send notification to the second user on expiration of the predefined duration of the event of the first user, wherein the notification is a reminder indicating the availability of the first user to respond to calls.

4. The system of claim 1, wherein the event module is configured to group the events in one or more categories.

5. The system of claim 1, wherein the event module is configured to enable the first user to select at least one category to display the events grouped under the selected category.

6. The system of claim 1, wherein the modes of messages include an audio mode, a video mode, a sticker-based mode, a text mode and an image-based mode.

7. The system of claim 1, wherein the message comprises at least one of text, emoji, emoticons, graphics, audio, image, and video.

8. The system of claim 1, wherein the module further comprises a contact management module configured to enable the first user to assign one or more contacts to at least one message, wherein the contact includes a phone number.

9. The system of claim 1, wherein the contact management module is configured to store information related to contacts and corresponding messages to be displayed on receiving call from the respective contact.

10. The system of claim 1, wherein the notification module and the communication module are configured to automatically send the message and send the notification to the assigned contacts, respectively.

11. A method for managing and responding to incoming calls, comprising the steps of:
providing a first user device associated with a first user, a second user device associated with a second user, at least one database for storing information related to the first user and the second user, and at least one server in communication with the first user device, the second user device and the database via a network, wherein the server comprises at least one memory for storing one or more program modules and at least one processor configured to execute the program modules;
providing, at the server via an input module, one or more modes to create the message and enabling selection of at least one mode to create at least one message;
displaying, at the server via an event module, one or more events and enabling the first user to select at least one event that corresponds to a plan of the first user;
enabling, at the server via a timer module, the first user to define a duration of the selected event;
creating, at the server via a message creation module, message comprising information related to the event and duration related to the event of the first user, wherein the message provides a reason of unavailability of the first user and the duration indicates a time duration that the second user needs to wait to contact the first user in real time, and
automatically sending, at the server via a communication module, the message to the second user device, when the first user receives a call from the second user during the predefined duration of the event.

12. The method of claim 11, wherein the first user is a call recipient and the second user is a caller, and wherein the first user device and the second user device are a communication device.

13. The method of claim 11, further comprising a step of: sending, at the server via a notification module, notification to the second user on expiration of the predefined duration of the event of the first user, wherein the notification is a reminder indicating the availability of the first user to respond to calls.

14. The method of claim 11, wherein the event module is configured to group the events in one or more categories.

15. The method of claim 11, wherein the event module is configured to enable the first user to select at least one category to display the events grouped under the selected category.

16. The method of claim 11, wherein the modes of messages include an audio mode, a video mode, a sticker-based mode, a text mode and an image-based mode.

17. The method of claim 11, wherein the message comprises at least one of text, emoji, emoticons, graphics, audio, image, and video.

18. The method of claim 11, further comprises steps of: enabling, at the server via a contact management module, the first user to assign one or more contacts to at least one message, wherein the contact includes a phone number, and
storing, at the server via the contact management module, information related to contacts and corresponding messages to be displayed on receiving call from the respective contact.

19. The method of claim 18, further comprises a step of: automatically sending, at the server via the communication module, to the second user device, if the first user receives a call from the second user during the predefined duration of the event and if the first user has assigned the second user as a contact to send the message.

20. The method of claim 18, further comprising steps of:
automatically sending, at the server via the communication module, the message to the assigned contacts, and
automatically sending, at the server via the notification module, the notification to the assigned contacts.
